(19) United States
(12) Patent Application Publication
(10) Pub. No.: US 2012/0305683 A1
(43) Pub. Date: Dec. 6, 2012

(54) Material Grinding Method and a Device for Carrying out Said Method

(75) Inventor: Chuguevsky Andrei Yurievich, Moskovskaya obl., (RU)

(73) Assignee: ARTER TECHNOLOGY LIMITED, Guernsey (RU)

(21) Appl. No.: 13/142,196

(22) PCT Filed: Dec. 7, 2009
(86) PCT No.: PCT/RU2009/000671

§ 371 Date: Aug. 22, 2012

(30) Foreign Application Priority Data
Dec. 25, 2008 (RU) 2008151417

(51) Int. Cl. B02C 19/06; B02C 23/02

(52) U.S. Cl. 241/5; 241/39

(57) ABSTRACT

The essence of the invention is that it involves the feed of a material to be ground and the acceleration of said material. During acceleration, jets are formed from a mixture of material to be ground and air and said mixture is fed to an annular grinding chamber. Simultaneously, a stream of air is fed into the grinding chamber in a direction contrary to that of the mixture jets. Local cyclic variations in the pressure and rate of the air stream and/or in the pressure and rate of the mixture jets are formed along the perimeter of the grinding chamber. The finished product is removed. The material grinding device comprises a housing with a unit for the feed of the material to be ground and a unit for the removal of the finished product. An annular grinding chamber is accommodated in the housing. Two rotating rotors with the blades fastened thereto are coaxially arranged in the housing. The blades for accelerating the material to be ground and feeding said material into the grinding Chamber and/or the blades for feeding air into the grinding chamber are arranged at varying intervals.

The invention is applied to machines for grinding of mineral and phytogenous materials and may be used in building, mining, chemical, power and other industries.

There is a method of material grinding that includes such stages as supply of the grinding material, acceleration of grinding material with formation of streams of mixture from the grinding material and air, and further mixture supply to a grinding chamber, and removal of the ready-made product.

There is a machine known which helps implementing the above-said technology and includes a frame with appliances for the supply of grinding material and removal of the ready-made product respectively, a grinding chamber, two rotatable rotors installed on a frame in alignment and the nozzles for forming of streams from the grinding material and the air fixed on one of the rotors (see, for example, the patent of the Russian Federation No. 2108160, cl. B02C 19/06, published on Apr. 10, 1998).

According to the known technical solutions the material is grinded due to multiple collision of epy grinding material with rotating targets which are arranged in concentric circles and fixed on the rotors. The methods and the machine described above concede large percentage of unmilled grinding material particles in the ready-made product since there is a possibility that some particles may not contact with at least some part of the targets. The appearance of the unmilled particles in the ready-made product reduce its homogeneity, and that in turn requires the regrinding process. At that it should be noted that the implementation of the known technology and the machine requires increased energy consumption since the material may be grinded only through the colliding of the particles of the grinding material with a man-made obstacle (target). Because of this condition the energy consumption during the grinding process is increased.

The closest technical analogue, also by the technical result achieved to the claimed technology, is a method that includes such operations as the supply of the grinding material, acceleration of the grinding material with formation of streams of mixture composed of the grinding material particles and the air, and further supply of the mixture to an annular grinding chamber, simultaneous delivery of air flows into an annular grinding chamber towards the streams of mixture, and removal of the ready-made product.

The closest technical analogue, also by the technical result achieved to the claimed technology, is the machine for material grinding which consists of a frame with appliances for then supply of grinding material and removal of the ready-made product respectively, an annular grinding chamber, two rotatable rotors fixed on a frame in alignment, with blades for acceleration of the grinding material and its supply to a grinding chamber fixed on one rotor, and the blades for air delivery to a grinding chamber fixed on the second rotor (see, for example, Pat. No. 2,193,448 of the Russian Federation, clas. B02C 19/06, published on Nov. 27, 2002).

The above-mentioned technologies selected as the closest analogues partially eliminate the disadvantages of the known technical solutions described above, since they ensure the reduction of the energy consumption during the process of grinding at the expense of oncoming air flow impact on the grinding particles in a grinding chamber. Impossibility of particles grinding at preset dispersion due to rather high percentage of unmilled particles of the material in ready-made product may be referred to disadvantages of the known technical solution. As a result the process efficiency declines as the material would require the additional regrinding process.

The invention is intended to accomplish the task of developing such a technology and a machine which would ensure high efficiency of material grinding process. The technical result that may be achieved would consist in reduction of unmilled material particles by increasing the residing time of the particles of the grinding material in a grinding chamber at simultaneous intensification of the particles collision among themselves.

The objective was resolved due to the method (which includes the supply of the grinding material, acceleration of the grinding material with formation of streams of mixture from the grinding material and the air, and further supply of the mixture to an annular grinding chamber, and simultaneous air delivery to an annular grinding chamber towards the streams of mixture, and ready-made product removal) when there are local periodical changes of the air flow pressure and the speed, and/or of the value of the pressure and the speed of the stream of the mixture created along the perimeter of the annular grinding chamber.

Besides that the objective was accomplished due to the fact that the machine for material grinding consists of a frame with appliances for supply of the grinding material and removal of the ready-made product, an annular grinding chamber, two rotating rotors fixed on a frame and placed inside the cavity of the frame in alignment with the blades for acceleration of the grinding material, and sending it to a grinding chamber fixed on the one rotor, and blades for air delivery to a grinding chamber fixed on the second rotor, and these blades for acceleration and supply of the grinding material to a grinding chamber and/or the blades for air delivery into the grinding chamber that are fixed with the variable pitch.

The gist of invention is explained in drawings where

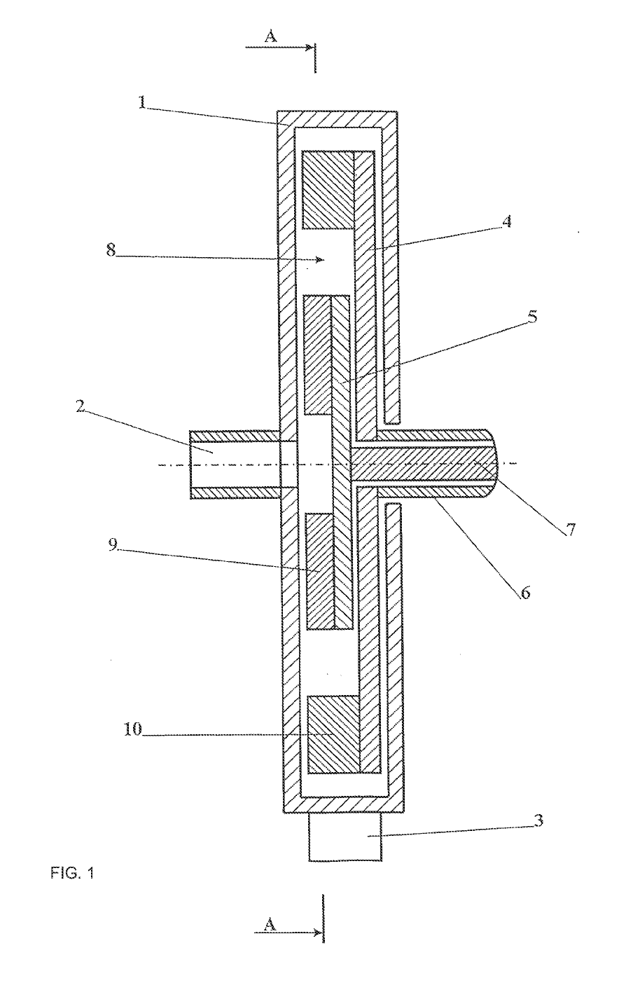

FIG. 1 represents sectional drawing of the grinding machine, and

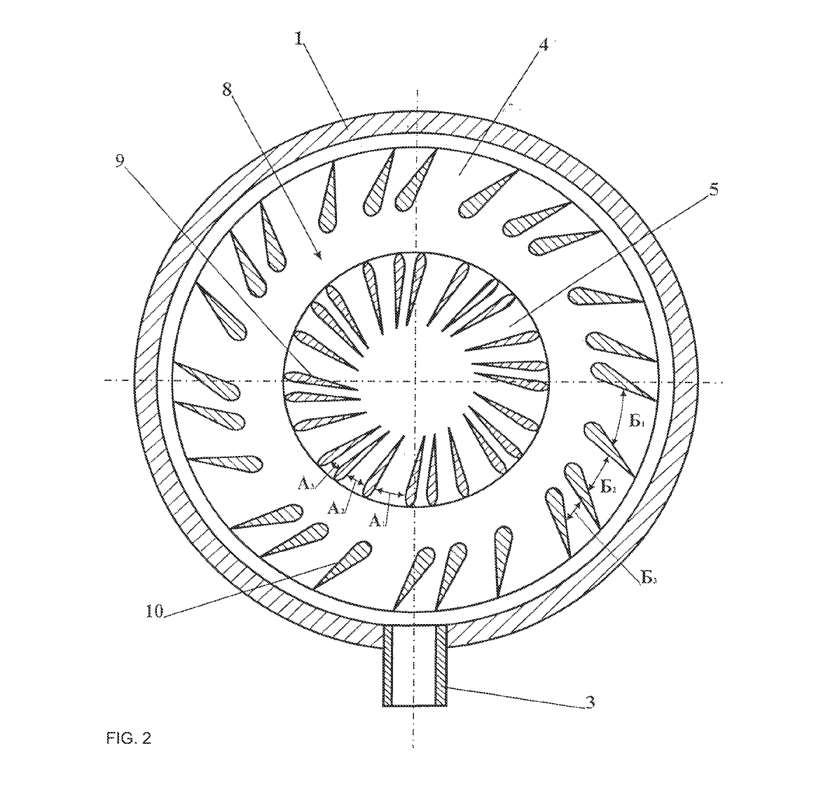

FIG. 2—the sectional drawing of A-A at FIG. 1.

According to the claimed method of material grinding the material should be preliminary prepared by destructing it into particles of certain size with the help of any known machine, for example, the mill or the crusher. After that the prepared grinding material is supplied to a grinding chamber with the help of any known appliance depending on the place of charging (for example, by compulsory supply with the help of screw-type feeder or by gravity flow with the help of loading hopper (the feeder). Being conveyed the material is accelerated, i.e. its conveyance speed is increased. Simultaneously with the grinding material acceleration the streams of mixture (consisting from the grinding material and the air) are formed and further supply of these mixture streams into a grinding chamber is carried out. At the same time the air flows are supplied to an annular grinding chamber towards the mixture streams. Highly accelerated particles of the grinding material, moving in a grinding chamber under the influence of the air flow moving towards them, change their direction into reverse and collide with the particles of the grinding material supplied to a grinding chamber afterwards. When colliding to each other the particles get destructed. At that local periodical changes of the pressure of the air flow and velocity magnitudes and/or the pressure of the mixture streams and velocity magnitudes are created along the perimeter of the annular grinding chamber. According to the first option of the method implementation only the magnitudes of pressure and velocity of air flow supplied towards the mixture streams are changed, and the magnitudes of the pressure of the mixture stream and the velocity remain constant. Under the second option only magnitudes of the pressure and velocity of the mixture streams are changed, whereas magnitudes of the pressure and velocity of the air flow are kept constant. But the most effective method is that under which the magnitudes of the pressure and velocity of both the air flow and the mixture streams are changed simultaneously. By implementing the options of the above-mentioned method the particles of the grinding material are undergone local periodical exposure from either the air flow, or the mixture streams, or even from both of them simultaneously. At that the amount of particles of the grinding material moving into an annular grinding chamber is increased significantly, and that considerably enhances the likelihood of collision of the particles of the grinding material between themselves. After that the ready-made product is removed from an annular grinding chamber with the help of any known appliance depending on place of unloading, for example, with the help of ventilating fan or unloading feeder. The example of the method implementation will be more precisely exposed while describing the machine that helps to introduce this method further below.

The machine for material grinding includes Frame 1 with Appliance 2 for the supply of the grinding material (shown schematically in drawings), and Appliance 3 for the removal the ready-made product (shown schematically in drawings). Appliance 2 for the supply of the grinding material into cavity of Frame 1 may be executed for example in the form of screw feeder (in case of vertical configuration of Frame 1) of any know design that provides forced material supply to the cavity of Frame 1 or in the form of hopper with the dozing device (in case of horizontal configuration of Frame 1 through which the grinding material is supplied into cavity if Frame 1 in certain quantities under the gravitation force. Appliance 3 for removal of the ready-made product may be executed, for example, in the form of pipe (tube) (in case of vertical configuration of Frame 1) through which the ready-made material is removed under the gravitation force from the cavity or in the form of an air pump (in case of horizontal configuration of Frame 1) which provides forced product removal form the cavity of Frame 1. There are two rotors—Rotor 4 and Rotor 5—which are installed in the cavity of Frame 1 in alignment. Each rotor has the shape of disc plate. Both rotors are capable to rotate inside Frame 1. Rotor 4 is kinematically connected to an engine (not shown in the drawings) with the help of Shaft 6. Electric, hydraulic or pneumatic engine may be used in the capacity of engine for the grinding machine. Rotor is kinematically connected to an engine (not shown in the drawings) of any known design with the help of Shaft 7. Torque is transferred to Shaft 6 and Shaft 7 through an appropriate reducer as from the general engine, so from the individual one. There is annular Grinding Chamber 8 inside the cavity of Frame 1. There are Blades 9 fixed on Rotor 5. These blades are meant for acceleration of the grinding material and its supply to the Grinding Chamber 8. Blades 9 may have a streamlined form, for example, wing- or plate-shaped (not shown in the drawings) and are connected to Rotor 5 with the help of detachable or non-detachable joint. There are Blades 10 for air delivery into the Grinding Chamber 8 fixed on Rotor 4. Blades 10 may have a streamlined form, for example, wing- or plate-shaped (not shown in the drawings) and are connected to Rotor 4 with the help of detachable or non-detachable joint. According to the one option of design execution of the machine Blades 9 for acceleration and supply of the grinding material to the Grinding Chamber 8 are arranged with variable pitch (Ai, A2 and A₃), i.e. the length of the arc determining the distance between the lateral faces of two Blades 9 (for acceleration and supply of the grinding material to the Grinding Chamber 8) placed in tandem is longer or shorter than the length of the arc determining the distance between the lateral faces of the adjacent pair of Blades 9 (for acceleration and supply of the grinding material to the Grinding Chamber 8) placed in tandem. This means that the following condition is met: Ai>A2>A3. At that Blades 10 for air delivery to the Grinding Chamber 8 are set with the constant pitch (not shown in the drawings). Under the second option of constructive execution of the machine for grinding Blades 9 (for acceleration and supply of the grinding material to the Grinding Chamber 8) are set with the constant pitch (not shown in the drawings). At that Blades 10 for air delivery to the Grinding Chamber 8 are set with the variable pitch ( [symbol] ₁, [symbol] ₂ and [symbol] ₃), i.e. the length of the arc determining the distance between the lateral faces of Blades 10 (for air delivery to the Grinding Chamber 8) arranged in tandem are longer or shorter than the length of the arc determining the distance between the lateral faces of adjacent pair of Blades 10 for air delivery to the Grinding Chamber 8. This means that the following condition is met [symbol] ₁> [symbol] ₂> [symbol] ₃. The third variation of the constructive design of the machine provides that Blades 9 (for acceleration and supply of the grinding material to the Grinding Chamber 8) are set with the variable pitch (Ai, A2 and A₃) and Blades 10 for air delivery to the Grinding Chamber 8 are set with the constant pitch (FIG. 2).

The machine for material grinding operates as follows.

Rotary drives of Shafts 6 and 7 which transmit the torque to Rotors 4 and 5 respectively should be switched on. Rotors 4 and 5 are being rotated in the opposite directions. Simultaneously the preliminary prepared grinding material is supplied to the cavity of Frame 1 with the help of Appliance 2 for the supply of grinding material. Grinding material enters the cavity of Frame 1 and is being captured by Blades 9 for acceleration of the grinding material and its supply to the Grinding Chamber 8. When entrapping the grinding material Blades 9 (for acceleration of the grinding material and its supply to the Grinding Chamber 8) simultaneously entrap the air what results in formation of the mixture of suspended solids from the grinding material and the air at the outlet of Blades 9. At that the particles of the grinding material are accelerated to the level of velocity of the rotation of Rotor 6. Since Blades 9 (for acceleration of the grinding material and its supply to the Grinding Chamber 8) are set with the variable pitch, it is obvious that the volume of the air entrapped at rotation of Rotor 5 will be different. Thus, when Blades 9 (for acceleration of the grinding material and its supply to the Grinding Chamber 8) are set with wider pitch (A₁), they will entrap more air at rotation of Rotor 5 than the blades set with the narrower pitch (A₂ or A₃). It appears from this that the air pressure in stream of the mixture outgoing from the channel formed by Blades 9 (for acceleration of the grinding material and its supply to the Grinding Chamber 8) set with wider pitch will be higher and the velocity will be lower than in a stream outgoing from adjacent channel formed by Blades 9 (for acceleration of the grinding material and its supply to the Grinding Chamber 8) set with the narrower pitch. Thereby during the rotation of Rotor 5 there are local periodic changes of the magnitude of stream mixture pressure and the velocity occurred along the perimeter of the annular Grinding Chamber 8 at the expense of change of its aerial component. Simultaneously at the rotation of Rotor 4 Blades 10 (for air delivery into the Grinding Chamber 8) rotating together with Rotor 4 create the air flow entering the Grinding Chamber 8 towards the mixture streams. Since Blades 10 (for air delivery into the Grinding Chamber 8) are set with the variable pitch, it is natural that the volume of the air entrapped by them will be differential. Thus Blades 10 (for air delivery into the Grinding Chamber 8) set with the wider pitch (B₁) will entrap the greater volume of the air at Rotor 4 than Blades 10 set with the narrower pitch ( [symbol] ₂ or [symbol] ₃). It follows from this that the air pressure in the air flow outgoing from a channel formed by Blades 10 (for air delivery into the Grinding Chamber 8) set with the wider pitch will be higher and the velocity will be lower than in the air flow outgoing from adjacent channel formed by Blades 10 (for air delivery into the Grinding Chamber 8) set with the narrower pitch. Thereby during the rotation of Rotor 4 there are local periodic changes of magnitudes of the pressure of the air flow and the velocity occurred along the perimeter of annular Grinding Chamber 8. The particles of the grinding material contained in mixture streams get into effective area of the air flow created by Blades 10 (for air delivery into the Grinding Chamber 8) and reverse the direction of their movement. Having changed th direction these particles collide with the particles of the grinding material moving in mixture streams towards them and their mutual destruction (grinding) is occurred. The process of movement of the particles of the grinding material is repeated manifold until more or less homogenous material is obtained. At that it should be noted that change of the magnitudes of pressure and velocity of the mixture stream entering the Grinding Chamber 8 or/and the magnitudes of pressure and velocity of the air flow entering the Grinding Chamber 8 towards the mixture streams bring the result that the particles of grinding material while in mixture streams are periodically accelerated and/or decelerated by the air flow. Given circumstance allows to increase the residence time of the particles of the grinding material in the Grinding Chamber 8 and therefore increase the probability of their collision between themselves what in turn allows to enhance the homogeneity of the material in the ready-made product.

The ready-made product is removed from the cavity of the Grinding Chamber 8 with the help of Appliance 3 meant for the removal of the ready-made product. The example of the method implementation is the following:

Rotary actuator (the drive) should be switched on and Rotor 4 and 5 begin to rotate. Rotation frequency of Rotors 4 and 5 should be kept equal to 5000 rpm for each. Preliminary prepared grinding material (with fineness of 4-5 mm) is supplied by dozes to the cavity of Frame 1 with the help of Appliance 2. Blades 9 entrap the grinding material inside the cavity of Frame 1. Blades are fixed on Rotors 5 with the variable pitch A₁=1.35 A₂, and A₂=1.4 A₃, that provides local change of the magnitudes of the pressure of the mixture streams and the velocity for 20% from 150-200 m/s of nominal velocity of mixture streams, outcoming from a channel formed by Blades 9 set with the narrowest pitch (A₃). Simultaneously the air flow created by Blades 10 fixed on rotating Rotor 4 enters the Grinding Chamber 8 in the opposite direction. Blades 10 are set on Rotor 4 with the variable pitch [symbol] ₁=1, 2 [symbol] ₂, and [symbol] ₂=1.3 [symbol] ₃, that provides local change of the magnitudes of the pressure of the air flow and the velocity approximately for 15% from 120-180 m/s of nominal velocity of the air flow outcoming from a channel formed by Blades 10 with the narrowest pitch ( [symbol] ₃).

1. The method of material grinding that includes the following stages: supply of the grinding material, acceleration of the grinding material with formation of streams of mixture from the grinding material and the air, and further supply of the mixture streams to an annular grinding chamber, simultaneous air delivery to an annular grinding chamber towards the mixture streams and the removal of the ready-made product, is distinguished by the fact that there are local periodical changes of magnitudes of the pressure of the air flow and the velocity and/or the pressure of the mixture streams and the velocity created along the perimeter of annular grinding chamber.

2. The machine for material grinding that includes a frame with appliances for the supply of the grinding material to an annular grinding chamber and the removal of the ready-made product respectively, two rotary rotors installed in alignment inside the frame with the blades for acceleration of the grinding material fixed on one rotor and blades for air delivery into the grinding chamber fixed on the second rotor, is distinguished by the fact that the blades for acceleration of the grinding material and its supply to the grinding chamber and/or blades for air delivery into the grinding chamber are arranged with variable pitch.
